(19) United States
(12) Patent Application Publication
(10) Pub. No.: US 2018/0141746 A1
(43) Pub. Date: May 24, 2018

(54) PORTION CAPSULE, SYSTEM AND METHOD FOR PRODUCING A BEVERAGE

(71) Applicant: K-FEE SYSTEM GMBH, Bergisch Gladbach (DE)

(72) Inventors: Marc Krüger, Bergisch Gladbach (DE); Günter Empl, Bergisch Gladbach (DE)

(21) Appl. No.: 15/578,293

(22) PCT Filed: Jun. 9, 2016
(86) PCT No.: PCT/EP2016/063200

§ 371 Date: Nov. 30, 2017

(30) Foreign Application Priority Data
Jun. 9, 2015 (DE) 10 2015 210 562.8

(51) Int. Cl. B65D 85/804

(52) U.S. Cl. CPC B65D 85/8043

(57) ABSTRACT

The invention relates to a portion capsule (1) for producing a beverage, having a substantially truncated cone-shaped or cylindrical capsule base body (2), which has a cavity (3) for receiving a beverage raw material (101), and a membrane (4) closing the cavity (100), wherein the capsule base body (2) has a capsule bottom (3), and wherein the capsule bottom (3) has an outlet opening (107), which is scaled with a detachable or pierceable film (108), and wherein the portion capsule (1) is configured without a filter, characterized in that the film (108) has a tensile strength of less than 80 N/mm².

### PRIOR ART

The invention is based on the portion capsule according to the preamble of claim 1.

It is well known from the prior art to prepare beverages by means of such portion capsules in corresponding beverage production machines. Beverage production machines of this type, also referred to as portion coffee machines, are known, for example, from the documents WO 2011/147 553 A1 or WO 2011/147 491 A1, while typical portion capsules are known, for example, from the documents WO 2012/038 063 A1 and WO 2010/085 824 A1.

The user always inserts a portion capsule filled with a raw beverage material into the beverage production machine, then closes the beverage production machine and starts the preparation mechanism. Upon closing of the beverage production machine, the portion capsule is perforated at at least two points, wherein hot water is introduced under pressure into the interior of the portion capsule through one of the two perforation openings and, by interaction of the hot water with the raw beverage material, the beverage is produced and flows out of the portion capsule through the other of the two perforation openings and is conducted into a corresponding drinking vessel. A disadvantage of these portion capsules is that the capsule base is customarily of relatively thick and stable design, and therefore the perforation means for perforating the capsule base is exposed to a high degree of wear, in addition, the capsule base here opens only slightly, and therefore the beverage exits through a very narrow gap between the perforation wall and the perforation means. Such beverage production machines are primarily conceived, however, for producing coffee. For this reason, the hot water is customarily introduced into the portion capsule under a high pressure of up to 19 bar. By means of the sudden loss of pressure when the beverage exits from the portion capsule through the narrow gap, the beverage is very greatly accelerated upon leaving the portion capsule. This applies all the more so if portion capsules are used without interior filter elements which additionally retard the beverage flow.

The high speed of the exiting beverage liquid disadvantageously leads to beverage liquid being splashed, as a result of which there is a considerable risk of scalding for the user of the beverage production machine, and the surroundings of the beverage production machine become soiled.

### DISCLOSURE OF THE INVENTION

It is therefore the object of the present invention to provide a simply producible and cost-effective portion capsule without a filter element for a beverage production machine, with which portion capsule, firstly, the increased wear at the perforation means can be eliminated and which, secondly, also permits the production of beverages without there being the risk of scalding for the user or soiling.

The object of the present invention is achieved by a portion capsule for producing a beverage, having a substantially frustaconical or cylindrical capsule base body, which has a cavity for receiving a raw beverage material, and a membrane closing the cavity, wherein the capsule base body has a capsule base, wherein the capsule base has an output opening which is sealed with a pierceable film, wherein the portion capsule is designed to be filter-free, and wherein the film has a tensile strength of less than 80 N/mm².

The portion capsule according to the invention has the advantage over the prior art that, at the point in the capsule base, at which the portion capsule is customarily perforated by the perforation means of the beverage production machine, there is already a premanufactured output opening which is closed only by a film, wherein the film has a comparatively low tensile strength. By means of the use of a film with such a low tensile strength, upon perforation of said film a comparatively large opening is formed in the film, and therefore the loss of pressure in the region of the outlet opening turns out to be lower and the beverage leaves the portion capsule at a lower speed. The risk of scalding of the user or soiling of the surroundings can therefore be advantageously eliminated. It has been shown that, when the film is perforated in a customary beverage production machine, from a tensile strength of less than 80 N/mm² a comparatively large opening is formed in the film, said opening leading to a significant retarding of the beverage flow from the portion capsule. The raw beverage material comprises in particular dissolvable instant powder or granules, such as, for example, coffee powder, chocolate powder, powdered milk, tea, soup powder or the like. Advantageous refinements and developments of the invention can be gathered from the dependent claims and from the description with reference to the drawings.

According to a preferred embodiment of the present invention, it is provided that the film has a tensile strength of less than 75 N/mm² and preferably of less than 70 N/mm². The film preferably has a tensile strength of between 20 and 70 N/mm². It has been shown that, specifically within this range, simple piercing can be achieved without excessive abrasion of the perforation means, with a large outlet opening being formed at the same time. It is conceivable for the film also to be designed in such a manner that it comprises an extension of between 1 and 30 percent, preferably of between 2 and 20 percent and particularly preferably of between 5 and 15 percent. A comparatively small extensibility of the film advantageously leads to the film being perforated reliably and relatively rapidly upon closing of the brewing chamber.

According to a further preferred embodiment of the present invention, it is provided that the film comprises a composite film composed of aluminum and plastic, in particular a PET/aluminum/PP95 composite film or a PET/aluminum/PP100 composite film. The film in particular has a material thickness of between 10 and 100 micrometers, preferably of between 20 and 70 micrometers and particularly preferably of between 40 and 60 micrometers.

According to a further preferred embodiment of the present invention, it is provided that the output opening is of substantially circular design, and the diameter of the output opening is between 10 and 60 percent, preferably between 20 and 50 percent and particularly preferably between 30 to 40 percent of the diameter of the capsule base. It is conceivable that the output opening is of substantially circular design and has a diameter of greater than 8 millimeters and preferably greater than 10 millimeters, in particular, the diameter of the output opening is smaller than 20 millimeters and preferably smaller than 14 millimeters. The diameter of the capsule base comprises in particular 25 to 35 millimeters, preferably 28 to 32 millimeters and particularly preferably substantially 30 millimeters.

The portion capsule according to the invention is designed to be filter-less, i.e. the raw beverage material in particular rests directly on the capsule base and no filter element, for example in the form of a strainer or paper, for holding back beverage granules is arranged between the raw beverage material and the capsule base.

A further subject matter of the present invention is a system having a beverage production machine and the portion capsule according to the invention, wherein the beverage production machine has a first and a second brewing chamber element, wherein the first and/or the second brewing chamber element is movable between a loading position, in which the first and the second brewing chamber element are spaced apart from each other for the introduction of the portion capsule into the beverage production machine, and a working position, in which the first and the second brewing chamber element are brought close to each other in order to form a substantially closed brewing chamber, wherein the second brewing chamber element has a perforation means which protrudes in the direction of the first brewing chamber element and, when the beverage production machine is transferred from the loading position into the working position, pierces the film on the capsule base in order to produce a beverage outlet.

In the case of the system according to the invention, the perforation means is preferably subject to significantly reduced wear since the perforation means does not pierce the stable base of the capsule base body, but rather merely the significantly thinner film.

According to a further preferred embodiment of the present invention, it is provided that the first brewing chamber element has a plurality of further perforation means which protrude in the direction of the second brewing chamber element and, when the beverage production machine is transferred from the loading position into the working position, pierce the membrane in order to form inlet openings.

A further subject matter of the present invention is a method for producing a beverage with the system according to the invention, wherein, in a first method step, the beverage production machine is provided in the loading position, wherein, in a second method step, the portion capsule is supplied to the beverage production machine, wherein, in a third method step, the beverage production machine is transferred from the loading position into the working position, as a result of which the perforation means pierces the film and the capsule base is perforated, and wherein, in a fourth method step, brewing water is forcibly supplied to the portion capsule.

The tensile strength and/or the extension of the film is determined in particular in a tensile test which is carried out, for example, on a universal testing machine and is a standardized standard method of material testing. The film is clamped, for example, in the universal testing machine and exposed to an increasing tensile loading until the film finally tears. During the test, a force-travel diagram or a stress-strain diagram is plotted, and the cross section and the length of the film are continuously measured. The tensile strength and the extension are directly read or calculated from the recorded data. The universal tension machine comprises, for example, a “Quasar 200” from “Schütz und Licht”, while the data are evaluated with “Graphwork” testing software of the manufacturer of the same name.

### BRIEF DESCRIPTION OF THE DRAWINGS

FIG. 1 shows a schematic sectional image view of a portion capsule according to an exemplary embodiment of the present invention.

FIGS. 2a, 2b show schematic views of a system and a method for producing a beverage according to an exemplary embodiment of the present invention.

### EMBODIMENTS OF THE INVENTION

In the various FIGS., identical parts are always provided with the same reference signs and are therefore generally also only named or mentioned once in each case.

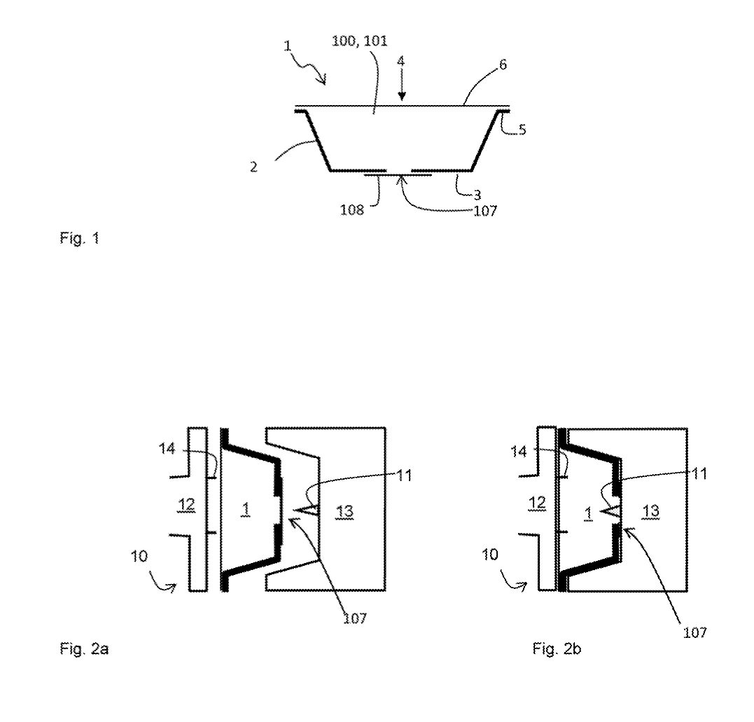

FIG. 1 illustrates a schematic sectional image view of a portion capsule 1 according to an exemplary embodiment of the present invention.

The portion capsule 1 here has a substantially rigid or semi-rigid frustaconical shape capsule base body 2 with a capsule base 3 and a filling opening 4. In the region of the filling opening 4, the encircling side wall of the capsule base body 2 ends with an encircling flange 5. The filling opening 4 serves for filling a cavity 100 in the interior of the portion capsule 1 with a raw beverage material 101. The cavity 100 is then closed in an air-tight manner with a membrane 6, wherein the edge of the membrane 6 is sealed onto the flange 5. The raw beverage material 101 comprises in particular dissolvable instant powder or granules, such as, for example, coffee powder, chocolate powder, powered milk, tea, soup powder or the like.

The capsule base 3 has a central output opening 107 which is closed by an air-tight film 108.

The film 108 is adhesively bonded onto the outside or lower side of the capsule base 3 and can be perforated by a perforation means (not illustrated) of a beverage production machine 10. The central output opening is in particular of circular design with a diameter of between 8 and 14 millimeters. The capsule base 3 preferably comprises a diameter of substantially 30 millimeters.

The film 108 is provided here in such a manner that it has a tensile strength of between 20 and 70 N/mm² and an extension of between 5 and 15 percent. This firstly permits easy perforation of the film 108 by a perforation means 11 of a beverage production machine 10 (cf, FIGS. 2a and 2b) and secondly produces a comparatively large beverage outlet in the capsule base 3 upon perforation, and therefore the outlet speed of the beverage is reduced. The tensile strength and the extension of the film 108 can be determined in particular with a universal tension machine, such as, for example, the “Quasar 200” from “Schütz und Licht”, and with “Graphwork” testing software from the manufacturer of the same name. The film 108 furthermore comprises a PET/aluminum/PP95 composite film or a PET/aluminum/PP100 composite film with a material thickness of between 40 and 60 micrometers.

The portion capsule 1 is furthermore designed to be filter-less, i.e. the raw beverage material 101 rests directly on the inner side or upper side of the capsule base 3.

FIGS. 2a, 2b are schematic views of a system and a method for producing a beverage according to an exemplary embodiment of the present invention. The system has the portion capsule 1 already described with reference to FIG. 1, and a beverage production machine 10.

In the present example, the beverage production machine 10 comprises a first brewing chamber element 12 and a second brewing chamber element 13. The first brewing chamber element 12 is displaceable relative to the second brewing chamber element 13 between a loading position illustrated in FIG. 2a and a working position illustrated in FIG. 2b. In the loading position, the first brewing chamber element 12 is spaced apart from the second brewing chamber element 13, and therefore the portion capsule 1 is insertable into the beverage production machine 10 and between the first and second brewing chamber element 12, 13, for example from above using gravitation force. The first brewing chamber element 12 is subsequently displaced in the direction of the second brewing chamber element 13 until the first and second brewing chamber elements 12, 13 together form a closed brewing chamber in which the portion capsule 1 is arranged.

The second brewing chamber element 13 is provided with a central perforation means 11, while the first brewing chamber element 12 has a plurality of further perforation means 14. When the brewing chamber is closed, the further perforation means 14 pierce the membrane 6 of the portion capsule 1 in order to produce inlet openings for introducing brewing water into the portion capsule 1, At the same time, the central perforation means 11 on the second brewing chamber element 13 perforates the sealing film 108 on the capsule base 3, specifically precisely in the region of the outlet opening 107. The perforation means 11 here are optionally pushed into the outlet opening 107. By perforation of the film 108, a beverage outlet is formed in the capsule base 3, through which the beverage produced in the portion capsule 1 by interaction between the brewing water and the raw beverage material can flow out of the portion capsule 1.

1) A portion, capsule for producing a beverage comprising:
a substantially frustaconical or cylindrical capsule base body, which has a cavity for receiving a raw beverage material, and
a membrane closing the cavity,
wherein the capsule base body has a capsule base, the capsule base has an output opening, which is sealed with a pierceable film,
wherein the portion capsule 1 is designed to be filter-free, and
wherein, the film has a tensile strength of less than 80 N/mm² and comprises an extension between 1 and 30 percent.

2) The portion capsule as claimed in claim 1, wherein the film has a tensile strength of less than 75 N/mm².

3) The portion capsule as claimed in claim 1, wherein the film comprises a tensile strength of between 20 and 70 N/mm².

4) The portion capsule as claimed in claim 1, wherein the extension is between 2 and 20 percent.

5) The portion capsule as claimed in claim 1, wherein the film has a material thickness of between 10 and 100 micrometers.

6) The portion capsule as claimed in claim 1, wherein the film comprises a composite film composed of aluminum and plastic, in particular a PET/aluminum/PP95 composite film or a PET/aluminum/PP100 composite film.

7) The portion capsule as claimed in claim 1, wherein the output opening is of substantially circular design, and a diameter of the output opening is between 10 and 60 percent, preferably between 20 and 50 percent and particularly preferably between 30 to 40 percent of a diameter of the capsule base.

8) The portion capsule as claimed in claim 1 , wherein the output opening is of substantially circular design, and has a diameter of greater than 8 millimeters.

9) The portion capsule as claimed in claim 8, wherein the diameter of the output opening is smaller than 20 millimeters.

10) The portion capsule as claimed in claim 1, wherein a diameter of the capsule base comprises 25 to 35 millimeters, preferably 28 to 32 millimeters and particularly preferably substantially 30 millimeters.

11) The portion capsule as claimed in claim 1, wherein the raw beverage material rests directly on the capsule base.

12) A system comprising
a beverage production machine, and
the portion capsule as claimed in claim 1,
wherein the beverage production machine has a first and a second brewing chamber element,
wherein the first and/or the second brewing chamber element is movable between a loading position, in which the first and the second brewing chamber element are spaced apart from each other for introduction of the portion capsule into the beverage production machine, and a working position, in which the first and the second brewing chamber element are brought close to each other in order to form a substantially closed brewing chamber,
wherein the second brewing chamber element has a perforation means which protrudes in a direction of the first brewing chamber element and, when the beverage production machine is transferred from the loading position into the working position, pierces the film on the capsule base in order to produce a beverage outlet.

13) The system as claimed in claim 12, wherein die first brewing chamber element has a plurality of further perforation means which protrude in the direction of the second brewing chamber element and, when the beverage production machine is transferred from the loading position into the working position, pierce the membrane in order to form inlet openings.

14) A method for producing a beverage with the system as claimed in claim 12, wherein:
in a first method step, the beverage production machine is provided in the loading position,
in a second method step, the portion capsule is supplied to the beverage production machine,
in a third method step, the beverage production machine is transferred from the loading position into the working position, as a result of which the perforation means pierces the film, and
in a fourth method step, brewing water is forcibly supplied to the portion capsule.

15) The portion capsule as claimed in claim 1, wherein the film has a tensile strength of less than 70 N/mm².

16) The portion capsule as claimed in claim 1, wherein the extension, is between 5 and 15 percent.

17) The portion capsule as claimed in claim 1, wherein the film has a material thickness of between 20 and 70 micrometers.

18) The portion capsule as claimed in claim 1, wherein the film has a material thickness of between 40 and 60 micrometers.

19) The portion capsule as claimed in claim 1, wherein the output opening is of substantially circular design, and has a diameter of greater than 10 millimeters.

20) The portion capsule as claimed in claim 8, wherein the diameter of the output opening is smaller than 14 millimeters.
